(19) United States
(12) Patent Application Publication
(10) Pub. No.: US 2006/0075678 A1
(43) Pub. Date: Apr. 13, 2006

(54) Artificial eye assembly for improving the hydrodynamic performance and attractiveness of a trolled baitfish

(76) Inventors: Charles Schammel, Port Orange, FL (US); Christy F. Harris, Port Orange, FL (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/965,464

(22) Filed: Oct. 13, 2004

(51) Int. Cl. A01K 85/00

(52) U.S. Cl. 43/42.09

(57) ABSTRACT

An artificial eye assembly is used to replace the natural eyes of a dead baitfish with a set of artificial eyes, thereby improving the attractiveness and hydrodynamic performance of the baitfish as it is trolled in the water. The eye assembly is preferably installed after removing the natural eyes during the rigging process in preparation for trolling. The artificial eye assembly provides the baitfish with a natural and attractive appearance for increasing the likelihood of a strike. A variety of different attachment structures are disclosed for securing the eye assembly to the baitfish. In one embodiment, the eye assembly includes two eye members, each of which includes a lip portion that forms a seal around the perimeter of each eye socket for inhibiting the entry of water. The seal reduces the rate of deterioration of the baitfish resulting from the removal of the natural eyes.

### BACKGROUND OF THE INVENTION

1. Field of the Invention

The present invention generally relates to devices and methods for preparing dead baitfish for trolling.

2. Description of the Related Art

A wide variety of different fishing lures have been proposed over the years for use by anglers. Typically, fishing lures are constructed to resemble baitfish and often include shiny and reflective patterns and colors. Some lures also include life-like eyes, scales and gills. However, fishing lures can only approximate the appearance of a natural baitfish and therefore have limited effectiveness. As a result, when trolling for certain types of sportfish, such as marlin, dorado or sailfish, it is common for anglers to use a dead baitfish, rather than a lure. Examples of commonly used baitfish include ballyhoo, bonito, mackerel, cigar minnows and mullet.

Although a dead baitfish typically appears more attractive to a sportfish than a fishing lure, there are still a number of drawbacks which limit the effectiveness of the baitfish. For example, in one primary drawback, the baitfish will often wobble or spin in an unnatural manner while being pulled through the water. These types of unnatural motions are sensed by the sportfish and substantially reduce the likelihood of a strike. Although these motions may be caused by a variety of factors, the spinning motion is often related to the unnatural position of the baitfish's eyes. For example, during the rigging process, a segment of the fishing line or rigging wire is typically passed transversely through the head in a manner that often damages the eyes of the baitfish. During the process, the eyes have a tendency to become partially dislodged or to bulge from the sockets. In addition, as the baitfish is pulled through the water, the force of the water may cause the eyes to bulge further outward. During trolling, the bulging eyes create asymmetric hydrodynamic forces that result in the wobbling or spinning motion.

In order to improve the motion of the baitfish during trolling, some anglers prefer to remove the fish's eyes during the rigging process. The eyes may be removed by a variety of different methods. However, in one commonly used method, a tool, such as a dowel, is passed transversely through the fish's head. This method can be used to completely remove the eyes while also creating a channel through the head wherein the rigging wire may be passed through for attaching the hook and line to the baitfish.

Although removal of the eyes has been found to successfully reduce or eliminate wobbling and spinning of the baitfish during trolling, the removal of the eyes also produces certain other undesirable effects. For example, it is known that sport fish are particularly attracted to the eyes of baitfish because they associate and identify the type of baitfish based on the appearance of the eyes. Therefore, the removal of the eyes causes the baitfish to appear much less attractive to the predator sportfish. Furthermore, it has been found that the transverse channel through the baitfish allows water to enter the fish's head during trolling. The flow of water tends to accelerate “washout” wherein the baitfish has a tendency to break apart due to the hydrodynamic forces.

### SUMMARY OF THE INVENTION

Preferred embodiments of the present invention provide an apparatus and method for simulating the natural eyes of a dead baitfish. The apparatus and method preferably allow for a relatively smooth and symmetric flow of water along the baitfish during trolling, thereby reducing wobbling and spinning motions. The apparatus and method also minimizes interference with the natural appearance of the baitfish for increasing the likelihood of a strike. Furthermore, the apparatus and method preferably provides a sealing mechanism that inhibits water from entering the channel formed in the fish's head during the rigging process, thereby extending the useful life of the baitfish. The apparatus and method is preferably inexpensive to manufacture, easy to transport and convenient to use.

With the above advantages in view, various preferred embodiments of an artificial eye assembly will now be discussed briefly. It will be appreciated by those skilled in the art that the preferred embodiments have several features, no single one of which is solely responsible for their desirable attributes. In one preferred embodiment, an artificial eye assembly is provided for use with a natural baitfish. The artificial eye assembly comprises a first eye member configured to resemble a natural eye and formed for placement along a first eye socket and a second eye member configured to resemble a natural eye and formed for placement along a second eye socket. An attachment means is provided for securing the first and second eye members in the first and second sockets. The attachment means may include, for example, an adhesive material, a lip portion for engaging tissue along the circumference of the socket, a male-female connector, a pin, flexible wires, an elastic band, penetrating elements, or an elongate member extending around the head. The artificial eye assembly preferably replaces only the eyes and thereby advantageously allows the remaining portion of the baitfish to remain exposed. Accordingly, the artificial eye assembly allows the baitfish to substantially maintain its natural appearance, feel and taste, thereby minimizing the likelihood of rejection by the sportfish.

Other features and advantages of the invention will become apparent from the following detailed description, taken in conjunction with the accompanying drawings, which illustrate, by way of example, preferred features of the present invention. However, neither this summary nor the following detailed description is intended to define the scope of the invention. Rather, the scope of the invention is defined by the claims.

### BRIEF DESCRIPTION OF THE DRAWINGS

Preferred features of an artificial eye assembly will now be discussed in detail with reference to the accompanying drawings labeled FIGS. 1 through 15, which are for illustrative purposes only.

FIG. 1 is a perspective view of a first preferred embodiment of an artificial eye assembly configured for use with a baitfish;

FIG. 2 is a side view of the artificial eye assembly shown in FIG. 1;

FIG. 3 is a side view illustrating a second embodiment of an artificial eye assembly wherein the inner sides of the eye members include mechanical coupling components;

FIG. 4A is a front view illustrating a third embodiment of an artificial eye assembly wherein simulated eyes are provided along first and second ends of a single cylindrical member and a pin is used for securing the assembly to the fish;

FIG. 4B is a side view illustrating the artificial eye assembly of FIG. 4A;

FIG. 5 is a perspective view illustrating the artificial eye assembly of FIGS. 4A and 4B secured to a baitfish;

FIG. 6A is a front view illustrating a fourth embodiment of an artificial eye assembly wherein simulated eyes are provided along first and second ends of a single cylindrical member and flexible wires are provided for securing the assembly to the baitfish;

FIG. 6B is a front view illustrating the artificial eye assembly of FIG. 6A wherein the flexible wires are twisted together;

FIG. 7 is a perspective view illustrating the artificial eye assembly of FIGS. 6A and 6B secured to a baitfish;

FIG. 8 is a front view illustrating a fifth embodiment of an artificial eye assembly wherein first and second eye members are coupled to an elastic band;

FIG. 9 is a perspective view illustrating the artificial eye assembly of FIG. 8 secured to a baitfish;

FIG. 10 is a front view illustrating a sixth embodiment of an artificial eye assembly wherein an elongate member connects first and second eye members together;

FIG. 11 is a perspective view illustrating the artificial eye assembly of FIG. 10 secured to a baitfish;

FIG. 12 is a front view illustrating a seventh embodiment of an artificial eye assembly wherein first and second eye members are connected by an elongate member and may be locked together using a mechanical coupling mechanism;

FIG. 13 is a perspective view illustrating the artificial eye assembly of FIG. 12 secured to a baitfish;

FIG. 14 is a plan view illustrating a kit for packaging and transporting an artificial eye assembly including a plurality of eye members releasably affixed to an elongate strip;

FIG. 15 is a side view illustrating the kit of FIG. 14;

FIG. 16 is a plan view illustrating another kit for packaging and transporting an artificial eye assembly including a plurality of eye members releasably affixed to a card; and

FIG. 17 is a side view illustrating the kit of FIG. 16.

### DETAILED DESCRIPTION OF THE PREFERRED EMBODIMENTS

Various preferred embodiments of artificial eye assemblies for use with dead baitfish will now be described. The artificial eye assemblies are configured to be quickly and easily installed into the baitfish during or after the rigging process. The specific eye assemblies depicted in the drawings and described herein are particularly well suited for use with ballyhoo, which is the type of baitfish shown in the drawings. As will be recognized, however, the invention is also applicable to other types of natural baitfish that may be used for trolling, including but not limited to bonito, small tuna, flying fish, mackerel, cigar minnows and mullet. The sizes and configurations of the eye assemblies described herein, and the associated rigging methods, may be appropriately adjusted for use with specific types and sizes of baitfish.

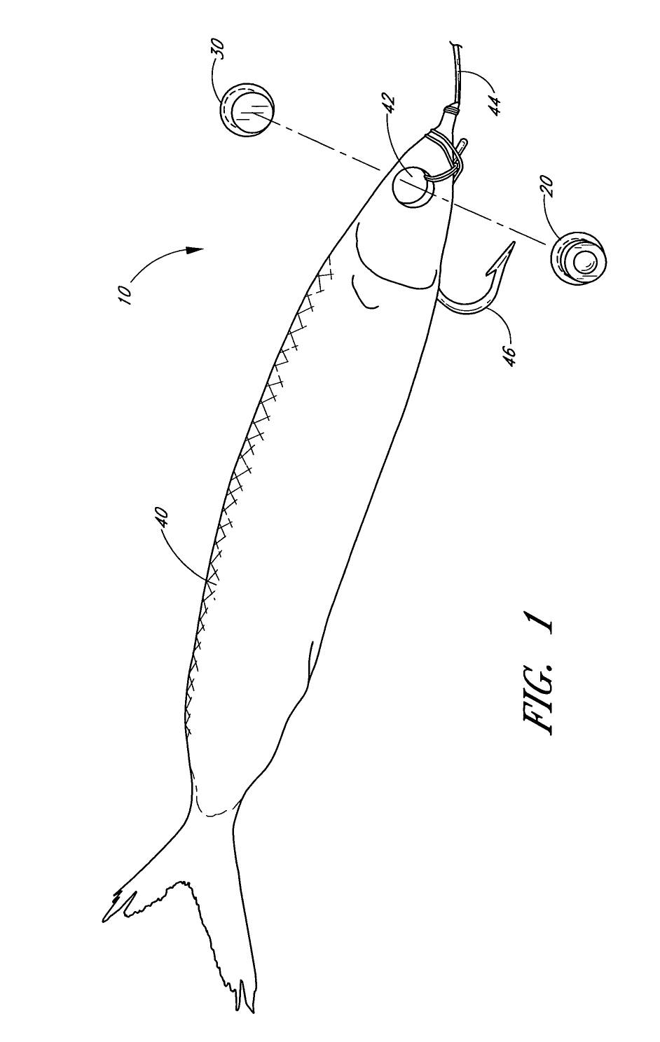

With reference now to FIG. 1, a perspective view of one preferred artificial eye assembly 10 is shown in combination with a natural baitfish 40, which is a ballyhoo in this example. It is assumed in this example that the real eyes of the baitfish have already been removed using a dowel, rod, knife or other tool. The artificial eye assembly comprises a first eye member 20 and a second eye member 30, wherein each of the eye members is a substantially disc-shaped member configured for securement to the baitfish.

For purposes of illustration, the baitfish 40 is shown after being rigged such that a transverse channel 42 is provided through the head portion. The eyes are preferably removed during formation of the transverse channel. Due to the bone structure around the eye sockets, the transverse channel also provides a very strong attachment point for attaching the fish line to the baitfish. As illustrated, a rigging wire (or leader) is passed through the transverse channel and around the fish's mouth or beak. The rigging wire holds the mouth shut such that water does not flow into the fish, thereby reducing washout and extending the useful life of the baitfish. A fishing line 44 is secured to a hook 46 that has been placed into the fish's head such that the barbed portion is positioned below the gills. The particular rigging method shown in FIG. 1 represents just one of many well-known rigging methods that may be used to secure the hook to the baitfish and the invention does not require the use of any particular rigging method. Although the eye assembly is typically installed after the ordinary rigging process of the baitfish, it may alternatively be installed during or prior to such rigging. As will be described in more detail below, the first and second eye members 20, 30 are sized and shaped for secure placement into the transverse channel 42 (i.e., sockets) for improving the natural appearance of the baitfish during trolling.

With reference to FIG. 2, a side view of the artificial eye assembly 10 of FIG. 1 is illustrated. The first eye member 20 is provided with an outer side 24 and an inner side 28. Similarly, the second eye member 30 is provided with an outer side 34 and an inner side 38. The outer sides 24, 34 provide eye portions that are shaped and colored to resemble natural baitfish eyes. In one preferred embodiment, the eye portions include raised central regions 26, 36 configured to simulate the appearance of a pupil. The inner sides 28, 38 of the first and second eye members 20, 30 preferably have substantially flat surfaces that are adapted for contact with each other. The two eye members 20, 30 may be identical in configuration.

In preferred embodiments, one or more attachment mechanisms may be provided with the artificial eye assembly for securely installing the eye members 20, 30 in the baitfish. For example, an adhesive material may be provided along the inner side of at least one of the eye members for coupling the eye members together after insertion into the transverse channel. The adhesive material may take a variety of different forms, such as, for example, a contact adhesive or contact cement that quickly adheres after contact and is substantially resistant to water.

With continued reference to FIG. 2, first and second lip portions 22, 32 extend along at least a portion of the first and second eye members 20, 30, respectively, to further enhance the securement of the eye members to the baitfish. The lip portions 22, 32 preferably extend around the entire circumference of each eye member. The lip portions are angled for allowing the eye members to be easily inserted into the channel that is formed by removing the eyes from the baitfish. In preferred embodiments, the lip portions are sufficiently flexible to bend inward during insertion such that the channel is not damaged or enlarged. However, after the eye members have been inserted, the outer edges of the lip portions engage the tissue along the inner wall of the channel for resisting dislodgment from the baitfish. The lip portions may be used with or without the adhesive material described above for securely installing the eye members in the baitfish. When used without adhesives, the eye members may be inserted into the eye sockets on either side of the head such that the lip portions engage tissue along the circumference of the sockets for resisting dislodgment. In this case, it is not necessary to create a transverse channel extending through the head. In another advantageous feature, the lip portions are also preferably configured for forming a seal that inhibits water from entering through the eye sockets.

With continued reference to FIG. 2, each of the eye members 20, 30 is preferably formed with a width that is equal to approximately one half the width of the head. Accordingly, when inserted into the transverse channel, the inner sides 28, 38 of the eye members 20, 30 are secured to each other by the adhesive while the outer sides 24, 34 are located in natural positions. Preferably, each of the eye members is formed with a diameter substantially equal to the diameter of the tool used to create the transverse hole. In one alternative embodiment, a system is provided wherein the artificial eye assembly 10 is provided in combination with a tool for creating the hole, thereby ensuring consistency between the tool size and the eye members.

Each of the eye members 20, 30 is preferably formed of a soft material, such as a soft plastic material. Preferably, the rigidity of the material is substantially equivalent to that of a natural eye, thereby reducing the likelihood of the sportfish rejecting the bait due to an unnatural feel. In one preferred method of manufacture, the eye members are injection molded. If necessary, the eye members may also be variable colored to increase the attractiveness of the baitfish. One or both of the eyes may optionally be manufactured with a red coloring selected to simulate the appearance of an injured baitfish (i.e., a “bleeding eye”). It is preferred that the eye members have a density slightly greater than that of water, such that the eye members sink to the bottom if not swallowed by a sportfish. In preferred embodiments, the eye members are configured for single use (i.e., sacrificial) and are made of an environmentally safe material, such as a degradable material that will not harm or pollute the environment.

In one preferred method of use, the natural eyes are first removed from the dead baitfish by forming a transverse channel 42 through the head. After forming the channel, the first and second eye members 20, 30 of the artificial eye assembly 10 are installed within the channel from opposite sides of the head. During installation, the angler may pinch the eye members together by pushing on the outer sides 28, 38, such as by using a thumb and forefinger, until the inner sides 24, 34 come into contact at a location along the central region of the transverse channel. The adhesive material couples the inner sides together such that the eye members become secured together as a single unit. The lip portions 22, 32 prevent the artificial eye assembly from sliding outward from the transverse channel, thereby firmly securing the artificial eye assembly 10 to the baitfish 40. The baitfish and artificial eye assembly may then be trolled.

During trolling, the artificial eye assembly provides the baitfish with improved hydrodynamics, such that the baitfish moves through the water with a substantially natural motion. Furthermore, the artificial eye assembly provides a sealing mechanism for preventing water from entering the transverse channel created during the rigging process. Still further, those skilled in the art will understand that a sportfish may bump, tap or taste a baitfish before striking. As a result, it will be understood that the artificial eye assembly provides a substantial advancement in the art by improving the hydrodynamics and sealing the transverse channel while also maintaining the natural appearance, feel and taste of the baitfish. Because the artificial eye assembly minimizes interference with the natural qualities of the baitfish and substantially maintains the appearance of a living fish, the artificial eye assembly substantially reduces the likelihood of rejection by the sportfish, thereby leading to greater success during fishing.

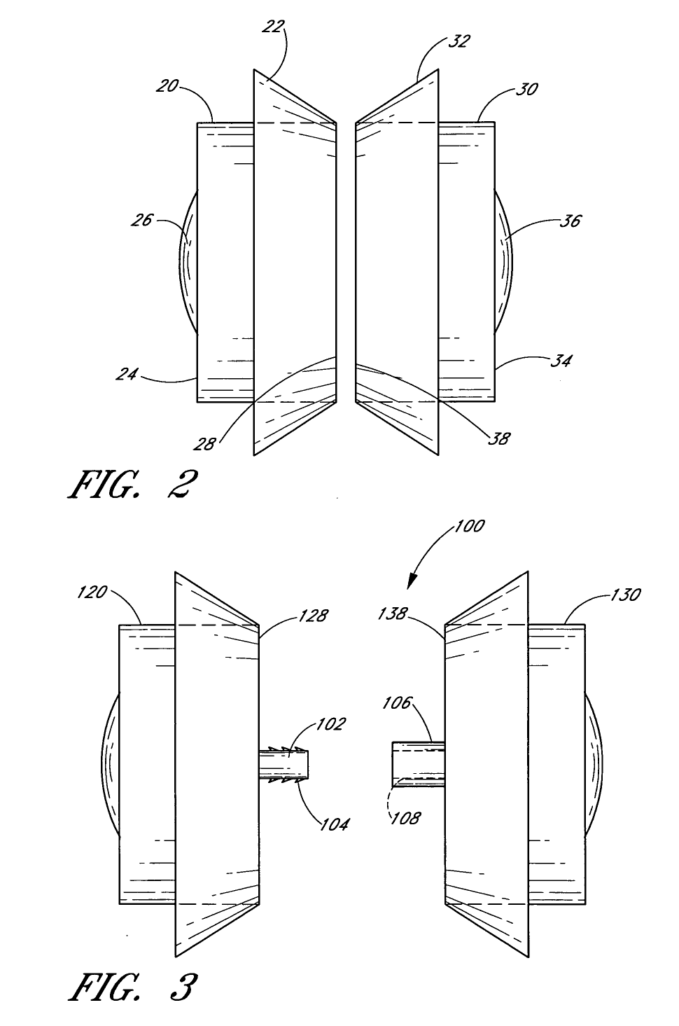

With reference now to FIG. 3, a second embodiment of an artificial eye assembly 100 comprises a first eye member 120 and a second eye member 130, wherein a mechanical coupling mechanism is provided for coupling the first and second eye members together during installation. In the illustrated embodiment, the mechanical coupling mechanism comprises an elongate extension 102 protruding from an inner side 128 of the first eye member 120 and a tubular member 106 protruding from an inner side 138 of the second eye member 130. The tubular member 106 is provided with a central hole 108 for receiving the extension 102 in a snug fit. The extension 102 and tubular member 106 thus form a male-female locking assembly. To further strengthen the connection between the extension 102 and the tubular member 106, the extension 102 may be formed with ribs or barbs 104 shaped for maintaining the extension 102 in the hole 108 and resisting backward movement.

In one advantageous feature of this embodiment, the extension 102 and tubular member 106 are configured such that the spacing between the first and second eye members is selectable. For example, in the configuration shown in FIG. 3, three different settings are possible, one for each set of barbs 104. Accordingly, the first and second eye members 120, 130 may be squeezed together until the desired spacing is achieved for providing the most natural looking position. In another advantageous feature of this embodiment, the angler is not required to create a transverse channel extending through the entire head. Rather, the first and second eye members may be placed in the eye sockets and the mechanical coupling mechanism may be used to penetrate the remaining tissue for mechanical attachment. In one variation of the artificial eye assembly 100 of FIG. 3, the hole 108 in the second eye member 130 may be formed directly into the body such that no tubular member is necessary. In another variation, the extension 102 and hole 108 may be formed with threads or locking components for coupling the first and second eye members together.

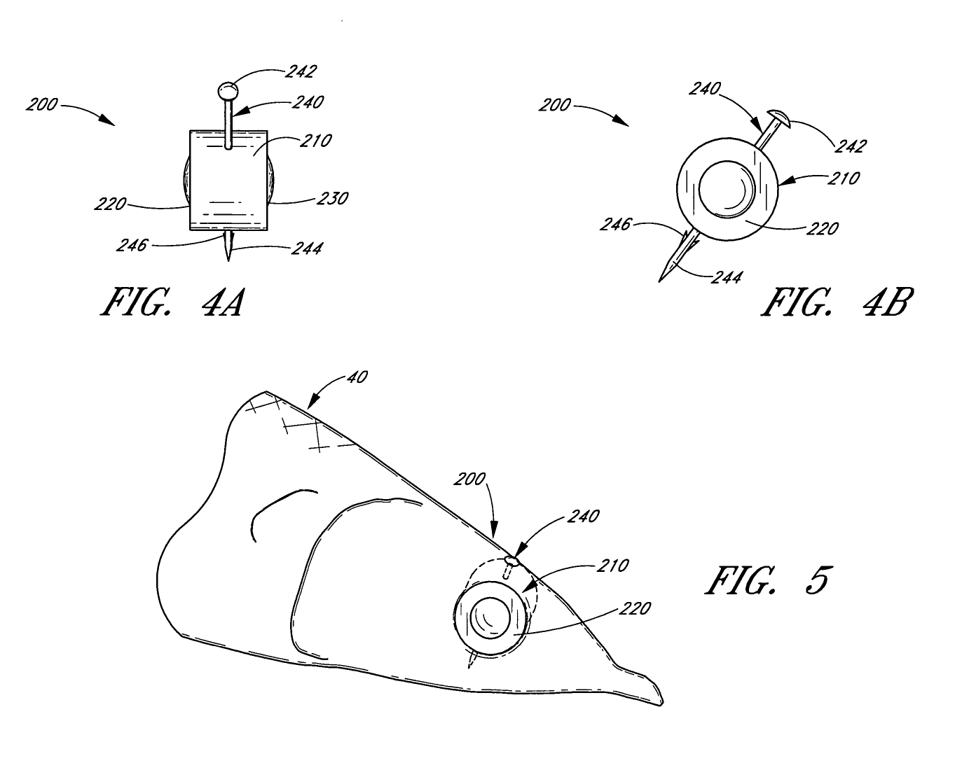

With reference now to FIGS. 4A and 4B, a third embodiment of an artificial eye assembly 200 comprises a substantially cylindrical member 210 having a first end 220 and a second end 230. First and second eye portions are disposed along the first and second ends, respectively, to resemble natural eyes. The cylindrical member 210 is a single unit sized for insertion into the transverse channel in the fish's head such that the simulated eyes on the first and second ends 220, 230 are visible on opposite sides of the fish's head in a natural location. Although a cylindrical member is a preferred shape, a wide variety of unitary members may be used with this embodiment. With particular reference to FIG. 4A, an attachment mechanism is provided for securing the cylindrical member 210 in the head after insertion. In one preferred embodiment, the attachment mechanism takes the form of a pin 240 that is insertable through the fish's head into the cylindrical member 210. The cylindrical member may be formed with a hole for receiving the pin or the body may be formed of a soft material such that the pin can penetrate the body. The pin is preferably formed with an elongate stem 244 and a flat head portion 242. As illustrated, one or more barbs 246 may be provided along the stem for holding the pin 240 in the cylindrical member 210 after insertion. A side view of the artificial eye assembly 200 is illustrated in FIG. 4B wherein the pin 240 has been inserted into the cylindrical member 210.

With reference now to FIG. 5, the artificial eye assembly 200 of FIGS. 4A and 4B is shown after securement to a baitfish 40. As illustrated, the cylindrical member 210 has been slidably inserted into the transverse channel in the head of the baitfish 40. Using this embodiment, the cylindrical member may be inserted from either side of the hole. In this perspective view, the second end 220 of the cylindrical member 210 is visible wherein a right eye is simulated. As illustrated, the pin 240 has been pushed downward through the head of the baitfish 40 into the cylindrical member 210 for securing the cylindrical member to the baitfish. The cylindrical member 210 may alternatively be held in place via protrusions or an adhesive on the outer surface, or by friction between the outer tubular surface and inner surface of the eye socket. Still further, the cylindrical member 210 may be configured to create the transverse hole, rather than being inserted into a previously formed hole.

In yet another variation, the cylindrical member 210 may be adapted to expand radially within the channel when squeezed from the ends, such that it retains its expanded configuration within the head. For example, in one variation, the cylindrical member may be formed of a malleable material, such as, for example, clay, putty or a soft plastic material. The cylindrical member is inserted through the channel and squeezed such that is expands in diameter to conform to the shape of the channel. An attachment mechanism, such as the pin 240 described above may be used to further secure the material within the channel. In this embodiment, each cylindrical member may be provided separately. Alternatively, a long tube may be provided wherein individual segments may be cut off as desired to provide the cylindrical members. The tube of malleable material preferably has a central dark portion for simulating the pupil, which is surrounded by a lighter portion for simulating the remaining portion of the eye.

With reference now to FIGS. 6A and 6B, a fourth embodiment of an artificial eye assembly 300 comprises another substantially cylindrical member 310 having a first end 320 and a second end 330. In this embodiment, an attachment mechanism is provided in the form of an upper pair of wires 340, 342, and a lower pair of wires 350, 352. The upper pair includes a first wire 340 extending from a first side 320 and a second wire 342 extending from a second side 330. Similarly, the lower pair includes a first wire 350 extending from a first side 320 and a second wire 352 extending from a second side 330. The first and second wires in each pair may be separate components or may be part of a single wire that extends through the cylindrical member 310. Each of the wires may, for example, be a copper wire having a small diameter. As illustrated in FIG. 6B, each of the wires is formed with sufficient length such that the upper pair of wires may be twisted together above the head and the lower pair of wires may be twisted together below the head.

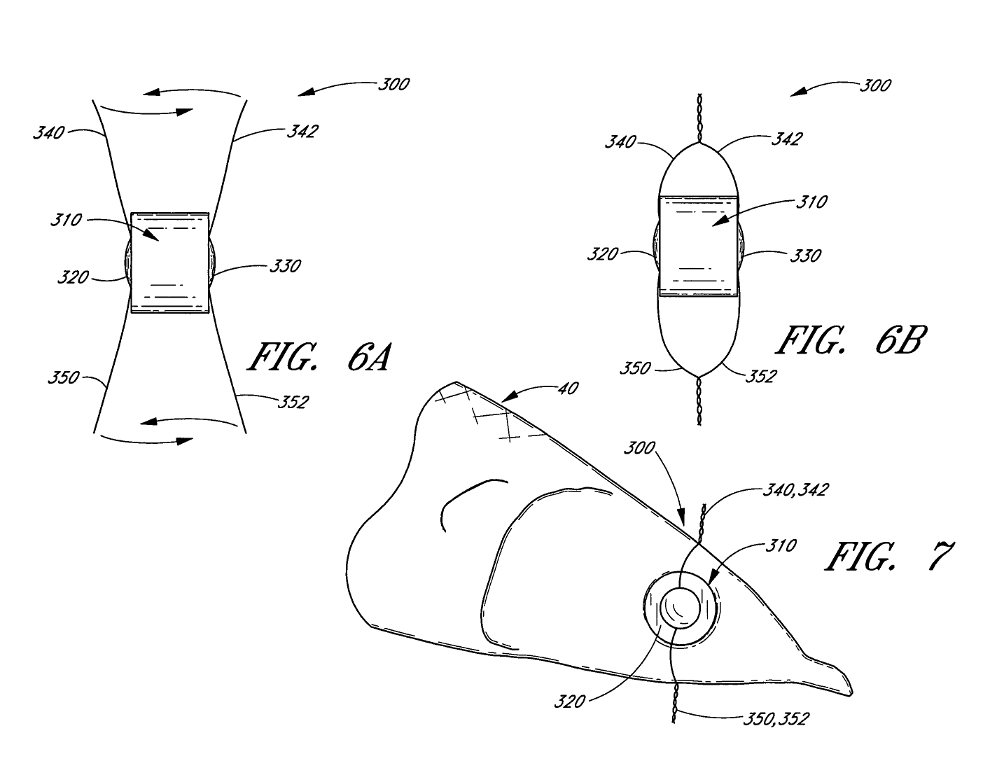

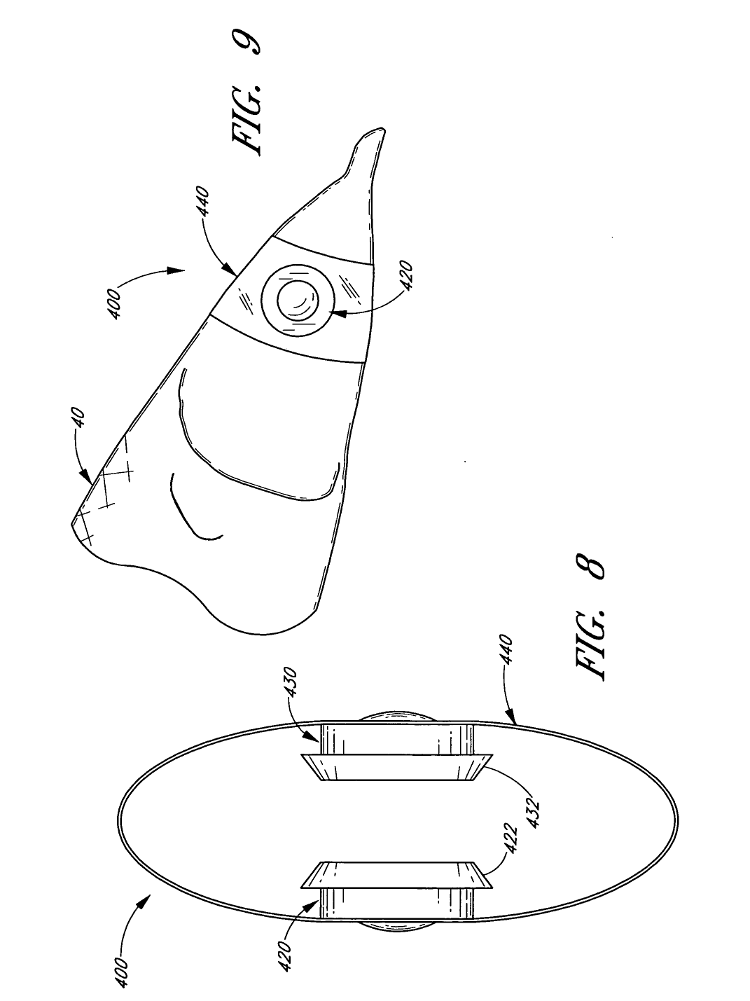

With reference now to FIG. 7, the artificial eye assembly 300 is shown after securement to a baitfish 40. As illustrated, the cylindrical member 310 is located within the transverse channel in the head and the upper wires 340, 342 have been twisted together above the head and the lower wires 350, 352 have been twisted together below the head. As a result of the intertwined wires, the cylindrical member is securely attached to the baitfish. It will be appreciated by those skilled in the art that this embodiment may take a variety of different forms while remaining within the scope of the invention. For example, in one variation, only a single pair of wires may be used to secure the artificial eye assembly to the baitfish. In another variation, the lower pair of wires may be adapted to pass through or engage the hook during the rigging process. In addition, the elongate members may take a variety of other forms, such as, for example, strings, strips, rubber bands or any other member capable of wrapping around a portion of the head for securing the assembly in place. In yet another variation, the cylindrical member may be formed with a hole extending transversely therethrough; in this embodiment, it may not be necessary to include any wire or other elongate members as part of the artificial eye assembly. Rather, a portion of the rigging wire may be passed through the hole in the cylindrical member during the rigging process for securing the cylindrical member to the baitfish.

With reference now to FIG. 8, a fifth embodiment of an artificial eye assembly 400 comprises a first eye member 420, a second eye member 430, and a tubular band 440. The first and second eye members are preferably attached or molded to the tubular band. In one preferred embodiment, the band 440 is a substantially elastic member configured to be placed around the head of the baitfish. In one variation, the band 440 is substantially clear (i.e., transparent or translucent) such that the natural appearance of the baitfish can be seen. In another variation, the band is provided with a particular color or pattern suited for matching the exterior appearance of the baitfish. As illustrated, the eye members may each by provided with a lip portion 422, 432 for securing the eye members to the baitfish and for improving the seal, thereby preventing water from entering the channel.

With reference now to FIG. 9, the artificial eye assembly 400 is shown after securement to a baitfish 40. After the baitfish has been rigged, the band 440 is stretched and placed around the head. The first eye member 420 is positioned on the right side of the head and the second eye member (not shown) is positioned on the right side of the head. The band is then released such that it contracts for a snug fit around the head. Preferably, the first and second eye members seat themselves within the transverse hole, with each eye member 420, 430 within a respective eye socket, for securely holding the eye assembly in place. Although the first and second eye members are illustrated as cylindrical bodies with a substantial thickness, in alternative embodiments, the eye members may be thinner in construction or may be provided as a pattern painted or otherwise disposed along the band. The band may be made from any stretchable material, such as rubber, that will sufficiently contract to secure the eye members to the baitfish. In one alternative embodiment, the band may include an adhesive material along the inner surface to enhance the securement of the band to the head of the baitfish.

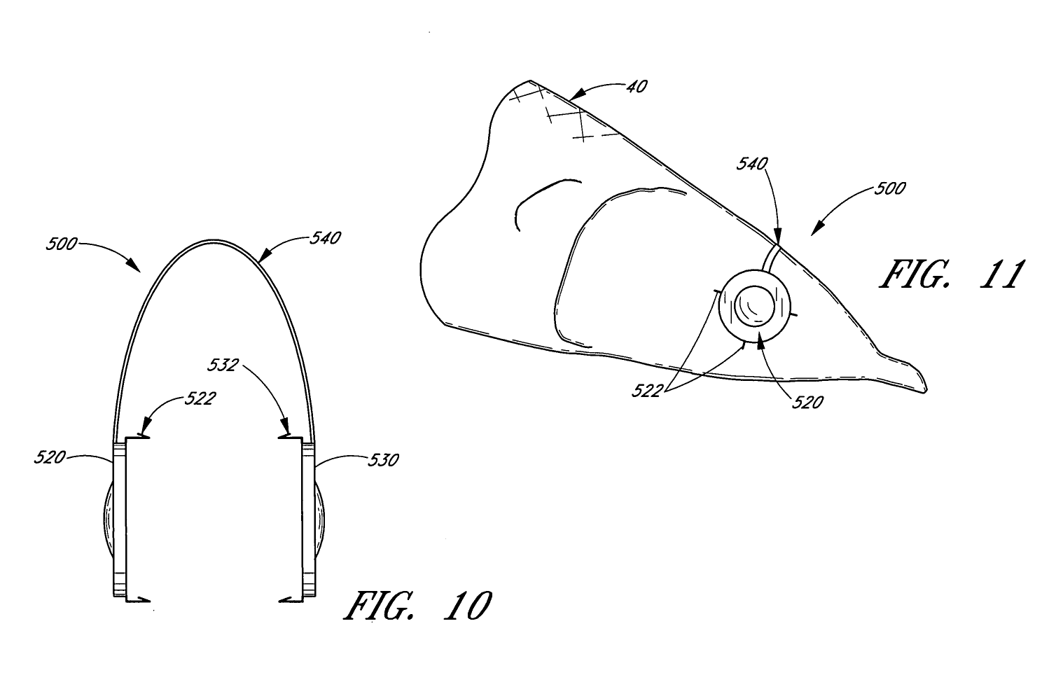

With reference now to FIG. 10, a sixth embodiment of an artificial eye assembly 500 comprises a first eye member 520 and a second eye member 530, wherein the eye members are coupled together by an elongate member 540. In one preferred embodiment, the elongate member 540 is formed of a soft, clear plastic or other soft material to maintain the natural appearance and feel of the baitfish. The first and second eye members 520, 530 are substantially flat members configured for placement along the sides of the head, preferably along the locations of the natural eyes. If desired, attachment mechanisms in the form of barbs or other penetrating elements 522, 532 may be provided along the first and second eye members 520, 530 for entering the tissue along the head.

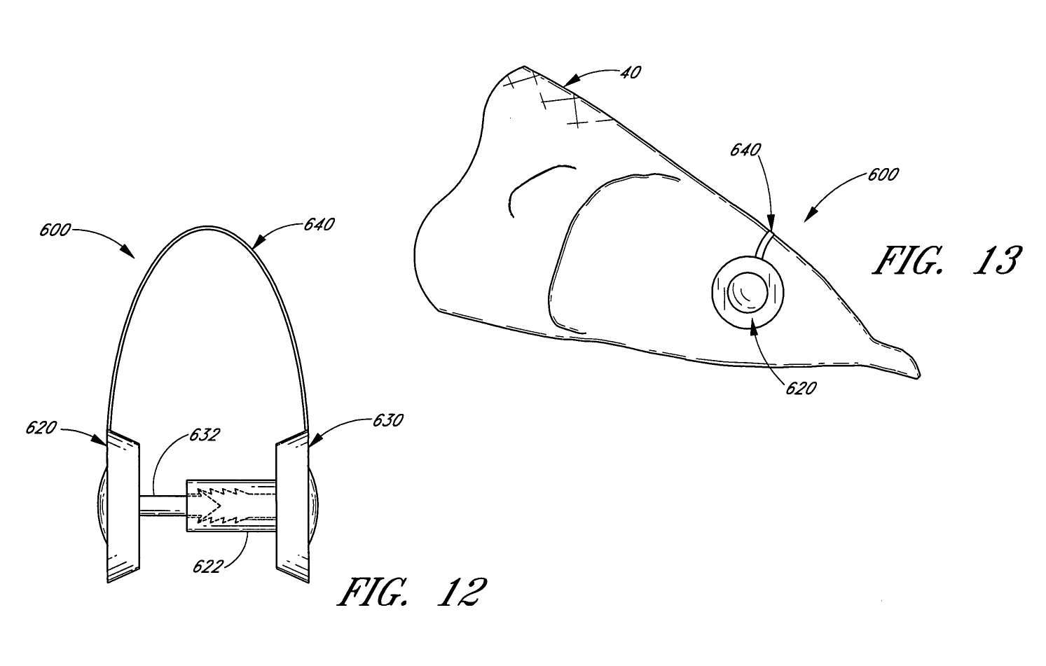

With reference now to FIG. 11, the artificial eye assembly 500 is shown after securement to a baitfish 40. The first and second eye members 520, 530 are positioned on the sides of the head and the eye members are then pinched together. The elongate member 540 provides a coupling portion that helps maintains the assembly in place. Furthermore, as the eye members 520, 530 are pinched together, the penetrating elements 522, 532 enter the tissue to further secure the artificial eye assembly 500 to the baitfish 40. In one alternative configuration, the elongate member 540 may be omitted, such that the artificial eyes are held in place solely by the penetrating elements. First and second eye portions are provided along the outer sides of the first and second eye members 520, 530 to resemble natural eyes.

With reference now to FIG. 12, a seventh embodiment of an artificial eye assembly 600 will now be described. This embodiment, which is similar in some respects to that described above with respect to FIGS. 10 and 11, comprises a first eye member 620, a second eye member 630, and an elongate member 640 for connecting the first and second eye members together. The first and second eye members 520, 530 are substantially disc-shaped members configured for insertion along opposite sides of the channel in the head. In this embodiment, a mechanical coupling mechanism is provided along the inner sides of the eye members for securing the eye members together. The mechanical coupling mechanism comprises an extension 632 and a tubular member 622 formed with a hole for receiving the extension.

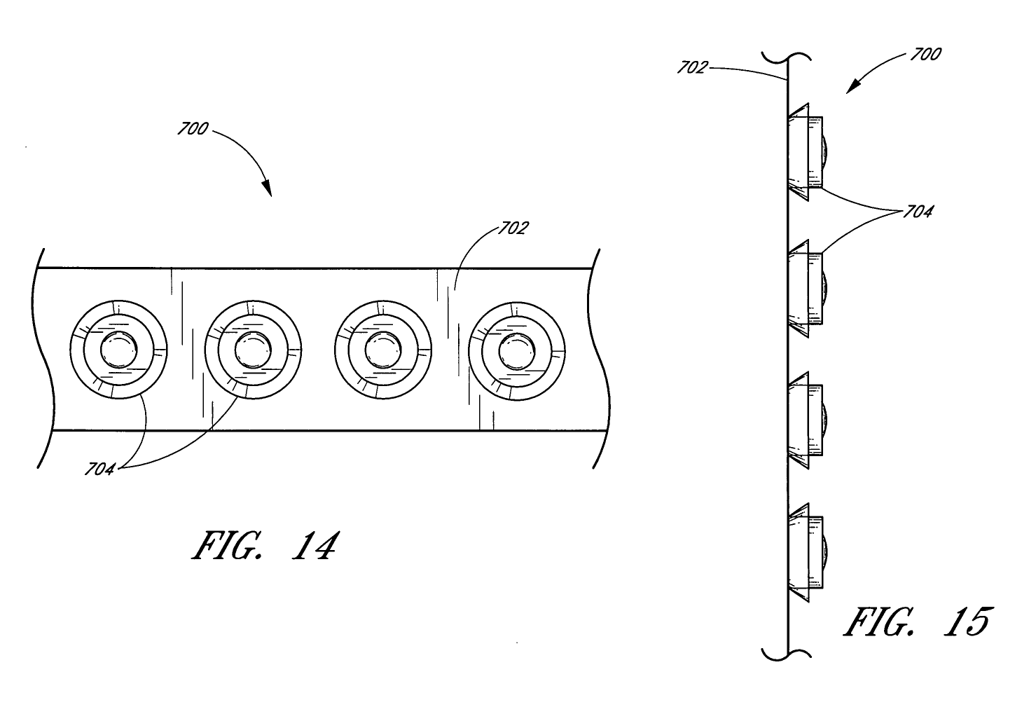

With reference now to FIG. 13, the artificial eye assembly 600 is shown after securement to a baitfish 40. During use, the eye members 620, 630 are placed on opposite sides of the head and are then pinched together. The pinching movement causes the extension 622 to snap fit into the hole in the tubular member 632, thereby securing the assembly to the head. Although a particular coupling mechanism is illustrated in FIGS. 12 and 13, any other type of snap fit mechanism or other mechanical coupling mechanism may be used while remaining within the scope of the invention.

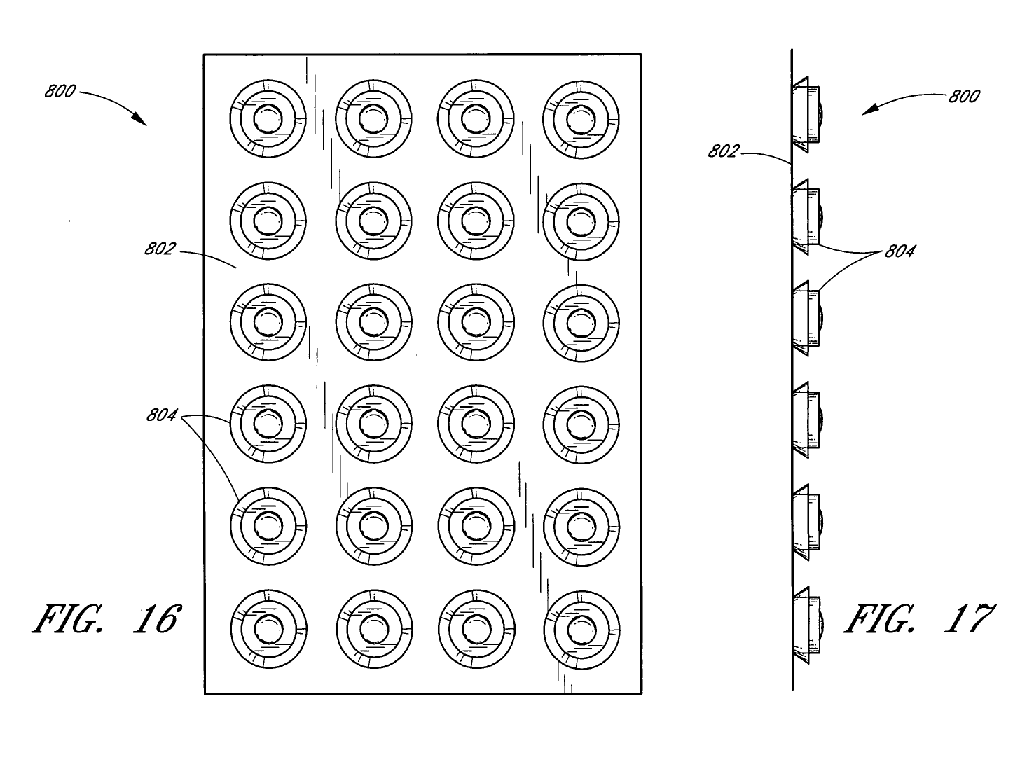

With reference now to FIG. 14, a kit 700 for use by anglers is illustrated wherein a plurality of artificial eyes 704 of the type described above with reference to FIGS. 1 and 2 is provided in combination with an elongate strip 702. The inner side of each of the eye members 704 is releasably affixed to the strip, such as with an adhesive material. However, each of the eye members 704 may be easily and conveniently peeled off the strip 702 as necessary during use. Furthermore, the strip may be torn at any location for selecting a desired number of eye members for a particular use, while leaving the remaining portion of the strip behind. The strip 702 may be formed of any suitable material such as wax paper or aluminum foil. A variety of different sizes of eyes may be provided on a single strip to accommodate different baitfish sizes. The eye members are preferably intended for single use. If desired, the strip may be rolled up for convenient storage and transportation. With reference to FIG. 15, a side view of the commercial product is shown.

With reference now to FIG. 16, another preferred kit 800 for use by anglers is illustrated wherein a plurality of artificial eyes 804 of the type described above with reference to FIGS. 1 and 2 is provided in combination with a card 802. The inner side of each of the eye members 804 is releasably affixed to the card, such as with an adhesive material. Similar to the elongate strip described above, each of the eye members 804 may be easily and conveniently peeled off the card 802 as necessary during use. The card 802 may be formed of any suitable material such as, for example, cardboard formed with a waxed surface. In one preferred configuration, the card has a 3 inch by 5 inch size for convenient transportation and storage, such as in an angler's pocket or a tackle box. With reference to FIG. 17, a side view of the commercial product is shown.

From the foregoing, it will be appreciated that each of the preferred embodiments of the artificial eye assembly can be quickly and conveniently used to replace the natural eyes of a baitfish. The artificial eye assemblies may be advantageously used to reduce or eliminate the problems associated with bulging eyes while maintaining a natural appearance. Still further, the assemblies are capable of being used with existing rigging techniques and prolong the useful life of the baitfish by reducing washout.

As will be apparent, different combinations of the above-described attachment mechanisms and other design features may be used within a given eye assembly. Thus the embodiments, described herein may be combined in various ways to form additional embodiments. The embodiments of the artificial eye assembly described herein are susceptible to modifications and alternate constructions that are fully equivalent. Consequently, it is not the intention to limit this artificial eye assembly to the particular embodiments disclosed. On the contrary, the intention is to cover all modifications and alternate constructions coming within the spirit and scope of the invention as expressed by the following claims, which particularly point out and distinctly claim the subject matter of the present invention.

What is claimed is:

1. A method for preparing a dead baitfish for trolling, comprising:
removing the natural eyes of the dead baitfish to form a channel that extends through the head of the dead baitfish; and
installing an artificial eye assembly within the channel of the head of the dead baitfish, the artificial eye assembly including first and second portions that resemble, respectively, first and second natural eyes of the dead baitfish.

2. The method of claim 1, wherein installing the artificial eye assembly comprises inserting a first eye member into a first end of the channel, and inserting a second eye member into a second end of the channel.

3. The method of claim 2, further comprising engaging a respective lip portion of each eye member within a respective eye socket of the dead baitfish to substantially form a seal that inhibits entry of water through the eye sockets during trolling of the rigged baitfish.

4. The method of claim 3, further comprising pushing the first and second eye members toward each other within the channel to cause the eye members to adhere to each other.

5. The method of claim 3, further comprising pushing the first and second eye members toward each other within the channel to cause the eye members to mechanically lock together.

6. The method of claim 5, further comprising, once the first and second eye members are locked together, adjusting a width of the eye assembly to one of a plurality of predefined settings.

7. The method of claim 1, wherein installing the artificial eye assembly comprises inserting into the channel a single member having a first end that resembles a first eye, and a second end that resembles a second eye.

8. The method of claim 1, wherein installing the eye assembly comprises inserting a pin into the head of the dead baitfish to hold the eye assembly in place within the channel.

9. The method of claim 1, wherein installing the eye assembly comprises wrapping first and second flexible elongate member around the head of the dead baitfish to hold the eye assembly in place within the channel.

10. The method of claim 1, wherein installing the eye assembly comprises placing a tubular band around the head of the dead baitfish, wherein the first and second eye members are disposed along the band.

11. The method of claim 1, wherein the dead baitfish is a ballyhoo.

12. The method of claim 1, further comprising, prior to installing the artificial eye assembly, rigging the dead baitfish with a fishing hook.

13. An artificial eye assembly for use with a dead baitfish, comprising:
first and second eye portions that resemble, respectively, first and second natural eyes of the dead baitfish; and
an attachment means for coupling the first and second eye portions to the baitfish.

14. The artificial eye assembly of claim 13, further comprising first and second eye members, the first and second eye members each having an inner side and an outer side, the first and second eye portions being provided along the outer sides.

15. The artificial eye assembly of claim 14, wherein the first and second eye members are configured for slidable insertion into a transverse channel formed in a head of the baitfish.

16. The artificial eye assembly of claim 15, wherein the inner sides of the first and second eye members are configured for engagement with each other after insertion into the channel.

17. The artificial eye assembly of claim 16, wherein the attachment means comprises an adhesive material disposed along at least one inner side for securing the first and second eye members together.

18. The artificial eye assembly of claim 14, wherein the attachment means comprises a first lip portion disposed along a circumference of the first eye member and a second lip portion disposed along a circumference of the second eye member.

19. The artificial eye assembly of claim 18, wherein the first and second lip portions are each configured to substantially form a seal that inhibits entry of water into the channel through the head during trolling of the rigged baitfish.

20. The artificial eye assembly of claim 14, wherein the attachment means comprises a mechanical coupling mechanism for securing the first and second eye members together.

21. The apparatus of claim 20, wherein the mechanical coupling mechanism comprises an elongate extension along the inner side of the first eye member and a tubular member along the inner side of the second eye member, the tubular member having a hole sized for receiving the elongate extension.

22. The apparatus of claim 14, wherein the attachment means comprises a tubular band, the first and second eye members being attached to the tubular band, the tubular band being configured to extend around the head.

23. The apparatus of claim 14, wherein the attachment means comprises an elongate member connecting the first and second eye members together, the elongate member being sized to extend around a portion of the head.

24. The apparatus of claim 14, wherein the attachment means comprises penetrating elements disposed along the inner sides of the first and second eye members for engaging tissue along the head.

25. The apparatus of claim 14, wherein the first and second eye members are made of a soft plastic material.

26. The apparatus of claim 13, further comprising a substantially cylindrical member, the first and second eye portions being provided along first and second ends of the cylindrical member.

27. The apparatus of claim 26, wherein the attachment means comprises a pin formed for extension through the head and into the cylindrical member.

28. The apparatus of claim 26, wherein the attachment means comprises a first wire coupled to the first end and a second wire is coupled to the second end, wherein the first and second wires are configured to extend around the head for attachment to each other.

29. An artificial eye assembly for use with a natural baitfish, comprising:
a first eye member having an inner side and an outer side, the outer side being configured to resemble a first natural eye, the inner side being covered with an adhesive material; and
a second eye member having an inner side and an outer side, the outer side being configured to resemble a second natural eye, the inner side being covered with an adhesive material;
wherein the first and second eye members are configured for insertion from opposite sides into a transverse channel formed through a head portion of the baitfish such that the inner sides of the first and second eye members engage each other and wherein the adhesive materials along the inner sides hold the first and second eye members together.

30. The artificial eye assembly of claim 29, wherein each of the first and second eye members further comprises a flexible lip portion.

31. A system for replacing the eyes of a baitfish, comprising:
a elongate tool having substantially round cross-section and sized for transverse insertion through a head of the baitfish, the tool being configured for removing the eyes and creating a transverse hole;
a first eye member adapted for insertion into the transverse channel from a first side; and
a second eye member adapted for insertion into the transverse channel from a second side.

32. A kit containing a plurality of eye members for replacing eyes of a baitfish, comprising:
an elongate strip of paper; and
a plurality of eye members disposed along the strip, each eye member being configured for insertion into an eye socket of a dead baitfish;
wherein the eye members have an inner side provided with an adhesive material such that the eye members are releasably affixed to the strip, and such that two eye members may be pressed together within a hollow eye socket region of the baitfish to cause the two eye members to adhere to each other.

33. The kit of claim 32, wherein the eye members are configured to form a seal that substantially inhibits entry of water into the channel through the head during trolling of the rigged baitfish.

34. The kit of claim 32, wherein the eye members are configured for insertion into the eye sockets of a ballyhoo.

35. A kit containing a plurality of eye members for replacing eyes of a baitfish, comprising:
a substantially flat card having a top surface; and
a plurality of eye members disposed along the top surface of the card, each eye member being configured for insertion into an eye socket of a dead baitfish;
wherein the eye members have an inner side provided with an adhesive material such that the eye members are releasably affixed to the top surface of the card, and such that two eye members may be pressed together within a hollow eye socket region of the baitfish to cause the two eye members to adhere to each other.

36. The kit of claim 35, wherein the top surface of the card is coated with a wax.
